(19) United States
(12) Patent Application Publication
(10) Pub. No.: US 2024/0427972 A1
(43) Pub. Date: Dec. 26, 2024

(54) SEMICONDUCTOR PACKAGE MODEL GENERATION SYSTEMS AND RELATED METHODS

(71) Applicant: SEMICONDUCTOR COMPONENTS INDUSTRIES, LLC, Scottsdale, AZ (US)

(72) Inventors: Klaus NEUMAIER, Erding (DE); James Joseph VICTORY, Trabuco Canyon, CA (US); Vaclav VALENTA, Brno (CZ); Sameer YADAV, Munich (DE); Wai Lun CHU, Kowloon (HK)

(73) Assignee: SEMICONDUCTOR COMPONENTS INDUSTRIES, LLC, Scottsdale, AZ (US)

(21) Appl. No.: 18/648,952

(22) Filed: Apr. 29, 2024

Related U.S. Application Data
(60) Provisional application No. 63/509,729, filed on Jun. 22, 2023.

(51) Int. Cl. G06F 30/31; G06F 111/20

(52) U.S. Cl. CPC G06F 30/31; G06F 2111/20

(57) ABSTRACT

Implementations of an object file for modeling using a three dimensional modeling module may include a first object defined as a root object, the first object corresponding with a first component of a semiconductor package; a second object corresponding with a second component of the semiconductor package directly physically coupled to the first component of the semiconductor package, the second object including a reference to the root object; and at least a third object corresponding with a third component of the semiconductor package, the third object including a reference to the root object, the third component of the semiconductor package directly coupled with a fourth component of the semiconductor package indirectly physically coupled to the second component of the semiconductor package.

### CROSS REFERENCE TO RELATED APPLICATIONS

This document claims the benefit of the filing date of U.S. Provisional Patent Application 63/509,729, entitled “MFIT Automated 3D Model Generation of Arbitrary Power Modules” to Neumaier et al. which was filed on Jun. 22, 2023, the disclosure of which is hereby incorporated entirely herein by reference.

### BACKGROUND

### 1. Technical Field

Aspects of this document relate generally to systems and methods used in semiconductor package design.

### 2. Background

Semiconductor packages have been devised that work to provide electrical connections between a semiconductor die and a circuit or motherboard to which a semiconductor package is attached. Some semiconductor packages mechanically protect a semiconductor die from shock or vibration. Other semiconductor packages help protect a semiconductor die from electrostatic discharge.

### SUMMARY

Implementations of a method of generating an object file for modeling with a three dimensional modeling module may include, using one or more processors, receiving a drawing interchange format file from a user using a first computer interface, the drawing interchange format file including a plurality of objects; and, using a second computer interface, receiving a selection of a semiconductor package type from the user; receiving from the user a selection of a SPICE model of least one semiconductor die; receiving coordinates of a location of the at least one semiconductor die; and receiving coordinates of a location of at least one electrical connector. The method may include, using an object file module, determining a root object of the plurality of objects of the drawing interchange format file; and using the coordinates of the location of the at least one semiconductor die, assigning a relationship of the at least one semiconductor die relative to the root object or any one object of the plurality of objects. The method may include recording in an object file a reference object for the at least one semiconductor die and one or more characteristics of the at least one semiconductor die; and, using the coordinates of the location of the at least one electrical connector, assigning a relationship of the at least one electrical connector relative to the root object or any one object of the plurality of objects. The method may include recording in the object file the reference object for the at least one electrical connector and one or more characteristics of the at least one electrical connector; and for each object of the plurality of objects: assigning a relationship for each object relative to one of the root object or another object of the plurality of objects to establish a reference object for each object; and recording in the object file the reference object for each object and one or more characteristics of each object; and storing the object file.

Implementations of a method of generating an object file for modeling with a three dimensional modeling module may include one, all, or any of the following:

The at least one electrical connector may be one of at least one bond wire, at least one clip, or both at least one bond wire and at least one clip.

The method may include receiving a selection of one of a resistor, a gate driver, a capacitor, or any combination thereof from the user using the second computer interface; receiving coordinates of a location of the one of a resistor, a gate driver, a capacitor, or any combination thereof; using the coordinates of the location of the one of a resistor, a gate driver, a capacitor, or any combination thereof, assigning a relationship of the one of a resistor, a gate driver, a capacitor, or any combination thereof relative to the root object or any one object of the plurality of objects; and recording in the object file the reference object for the one of a resistor, a gate driver, a capacitor, or any combination thereof and one or more characteristics of the one of a resistor, a gate driver, a capacitor, or any combination thereof.

The second computer interface may include a canvas portion on which the plurality of objects from the drawing interchange format file may be displayed and on which the user places the at least one semiconductor die and the at least one electrical connector at a desired position relative to the plurality of objects to establish the coordinates of the location of the at least one semiconductor die and the coordinates of the at least one electrical connector.

The second computer interface may include a button configured to execute the object file module with a current configuration of the plurality of objects, the at least one semiconductor die, and the at least one electrical connector displayed on a canvas portion.

The second computer interface may include a button configured to send the object file to the three dimensional modeling module for processing.

Implementations of an object file for modeling using a three dimensional modeling module may include a first object defined as a root object, the first object corresponding with a first component of a semiconductor package; a second object corresponding with a second component of the semiconductor package directly physically coupled to the first component of the semiconductor package, the second object including a reference to the root object; and at least a third object corresponding with a third component of the semiconductor package, the third object including a reference to the root object, the third component of the semiconductor package directly coupled with a fourth component of the semiconductor package indirectly physically coupled to the second component of the semiconductor package.

Implementations of an object file for modeling may include one, all, or any of the following:

The fourth component of the semiconductor package may correspond with a fourth object, the fourth object including a reference to one of the root object, the second object, or the third object

The first object, second object, and third object may each include one or more characteristics of the first component, second component, and third component, respectively.

The one or more characteristics may include one of a size, a material, or a name.

The second object may include a Z position relative to the root object.

The third object may include a Z position relative to the root object.

The fourth object may include a Z position relative to one of the root object, the second object, or the third object.

The three dimensional modeling module may be configured to begin modeling with the root object.

Implementations of a method of designing a clip may include, using one or more processors, receiving a drawing interchange format file from a user using a first computer interface, the drawing interchange format file including a plurality of objects; and, using a second computer interface, receiving a selection of a semiconductor package type from the user. The method may include receiving from the user a selection of at least one semiconductor die; receiving from the user a selection of a clip; and, using the second computer interface, receiving coordinates of a location of the at least one semiconductor die. The method may include receiving coordinates of an outer boundary of the clip; receiving a thickness of the clip; and within the outer boundary of the clip, receiving coordinates of at least one fixed portion of the clip. The method may also include, within the outer boundary of the clip, receiving coordinates of a first transition region of the clip.

Implementations of a method of designing a clip may include one, all, or any of the following:

Receiving coordinates of the outer boundary of the clip further may include receiving a distance to a clip reference.

The method may include, within the outer boundary of the clip, receiving coordinates of a hole in the clip.

The method may include, within the outer boundary of the clip, receiving coordinates of a second transition region of the clip and defining a flexible region between the first transition region and the second transition region.

The method further may include receiving a selection of a portion of the first transition region of the clip and, in response, receiving coordinates of a line where the first transition region may be not present.

The method may include generating a plurality of objects corresponding with the clip with an object file module and storing the plurality of objects in an object file.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a perspective view of an implementation of a semiconductor package prior to being molded or included in a housing;

FIG. 2 is a side view of the semiconductor package of FIG. 1;

FIG. 3 is a detail perspective view of a portion of the semiconductor package of FIG. 1;

FIG. 4 is an exploded perspective view of the implementation of the semiconductor package of FIG. 1;

FIG. 5 is a detail exploded view of a portion of the semiconductor package of FIG. 1;

FIG. 6 is a detail exploded view of a portion of the semiconductor package of FIG. 1;

FIG. 7 is a detail exploded view of a portion of the semiconductor package of FIG. 1;

FIG. 8 is a side exploded view of the semiconductor package of FIG. 1;

FIG. 9 is a diagram of a stack used in modeling an implementation of a semiconductor package;

FIG. 10 is a diagram of a stack used in modeling another implementation of a semiconductor package;

FIG. 11 is a diagram of a relationship between six objects relative to a coordinate axis;

FIG. 12 is a print out of a portion of an implementation of an object file;

FIG. 13 is a drawing of a computer interface with an outer boundary of a clip drawn thereon;

FIG. 14 is a drawing of the computer interface of FIG. 13 showing an extent of the clip of FIG. 13;

FIG. 15 is a drawing of the computer interface of FIG. 13 illustrating a location of a fixed portion of the clip;

FIG. 16 is a drawing of the computer interface of FIG. 13 illustrating four fixed portions;

FIG. 17 is a drawing of the computer interface of FIG. 13 illustrating two holes;

FIG. 18 is a drawing of the computer interface of FIG. 13 illustrating de-selection of a transition on edges of two of the fixed portions;

FIG. 19 is a drawing of the computer interface of FIG. 13 illustrating a storage selection for the user;

FIG. 20 is a flow chart of a first implementation of a method of modeling a semiconductor package;

FIG. 21 is a flow chart of a second implementation of a method of modeling a semiconductor package;

FIG. 22 is a block diagram of the components of a system for modeling a power electronics module;

FIG. 23 is a drawing of a plurality of objects included in a drawing interchange format view when viewed using a computer interface;

FIG. 24 is a drawing of a computer interface for receiving and processing a drawing interface file; and

FIG. 25 is a drawing of a computer interface for laying out package components, processing an object file, and generating a three dimensional model.

### DESCRIPTION

This disclosure, its aspects and implementations, are not limited to the specific components, assembly procedures or method elements disclosed herein. Many additional components, assembly procedures and/or method elements known in the art consistent with the intended semiconductor package model generating systems will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such semiconductor package model generating systems, and implementing components and methods, consistent with the intended operation and methods.

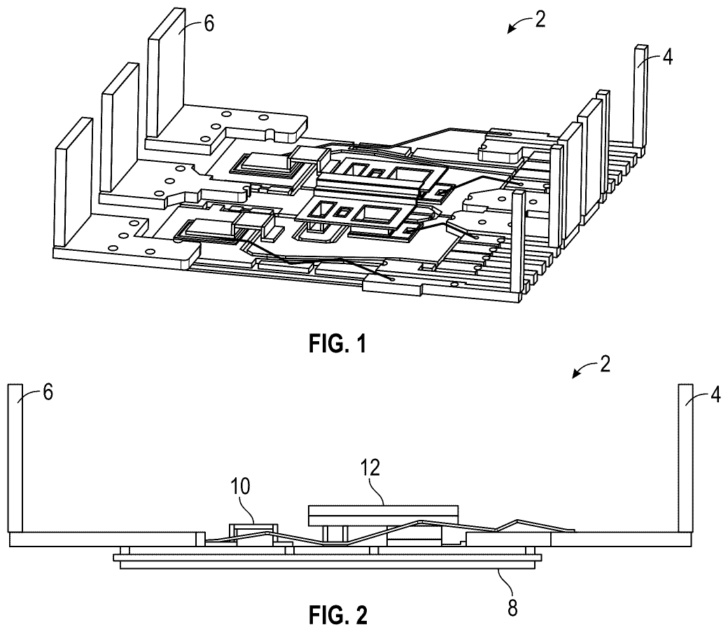

Referring to FIG. 1, a perspective view of an implementation of a semiconductor package 2 is illustrated. In this particular implementation, the structure of the semiconductor package 2 is illustrated prior to molding using a mold compound leaving the leads 4, 6 exposed or the fastening of a housing thereto which likewise leaves the leads 4, 6 exposed. FIG. 2 illustrates a side view of the semiconductor package 2 showing the relative height of the components of the package including the leads 4, 6, substrate 8, and clips 10, 12. Bond wires are also illustrated in FIGS. 1-2 which provide electrical connections between the various die and components of the leads and/or clips.

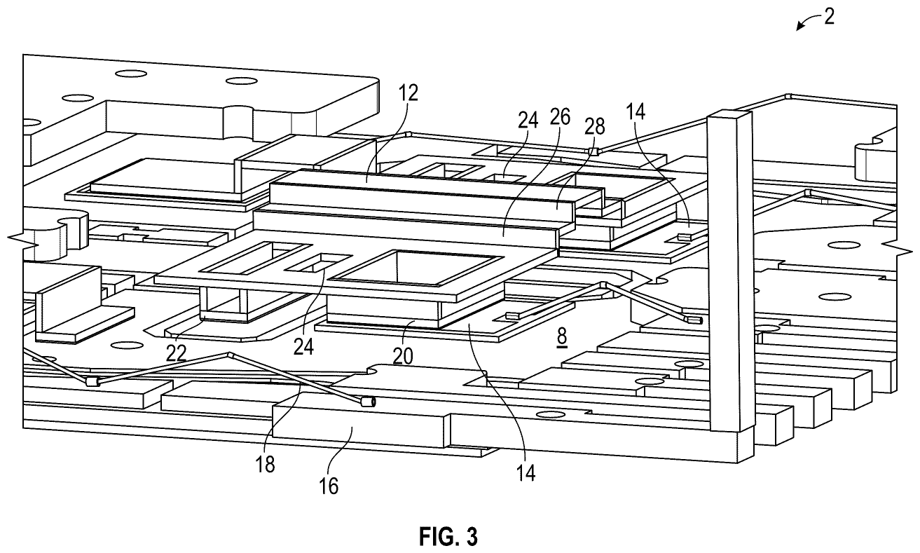

Referring to FIG. 3, a detail perspective view of the semiconductor package 2 is illustrated showing semiconductor die 14 that are bonded/attached to substrate 8. In this view, it can be seen that the lead 4 is attached to component 16 which is then attached to substrate 8 and to bond wire 18. In this view, the structure of the clip 12 is also visible, showing that it has fixed portions 20, 22 that attach to the semiconductor die 14 and portions of the substrate 8, holes therethrough 24, and transitional portions 26, 28 where the structure of the clip 12 rises between one height level above the substrate 8 to another height level forming a bridge between the two semiconductor die 14.

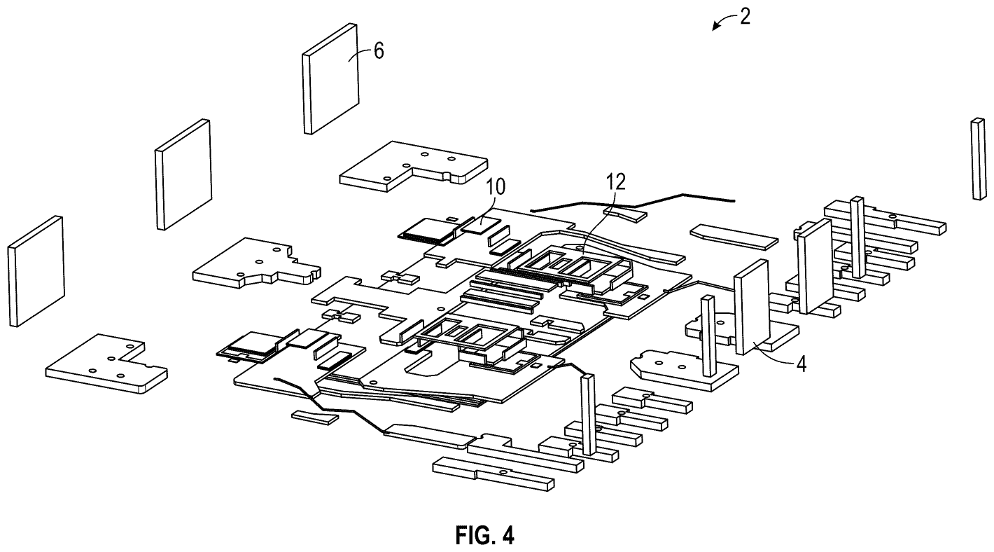

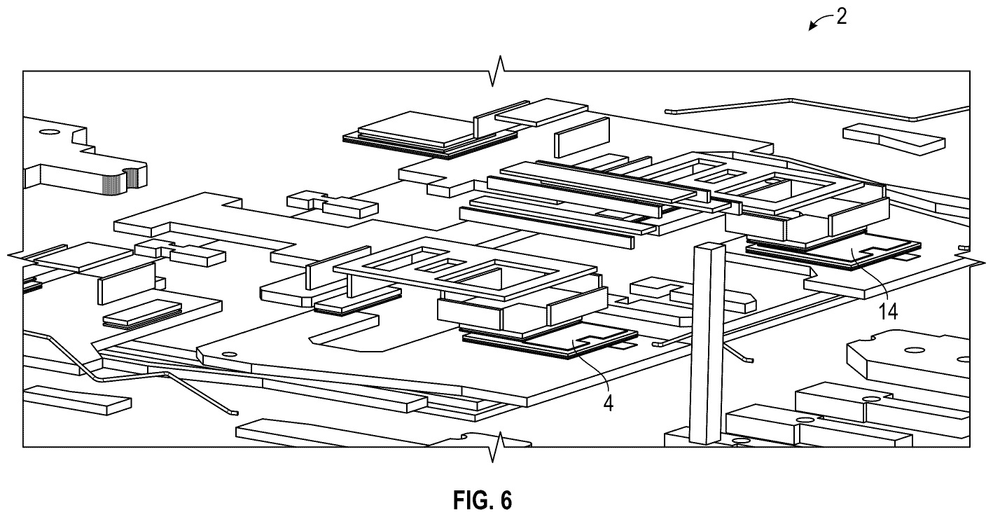

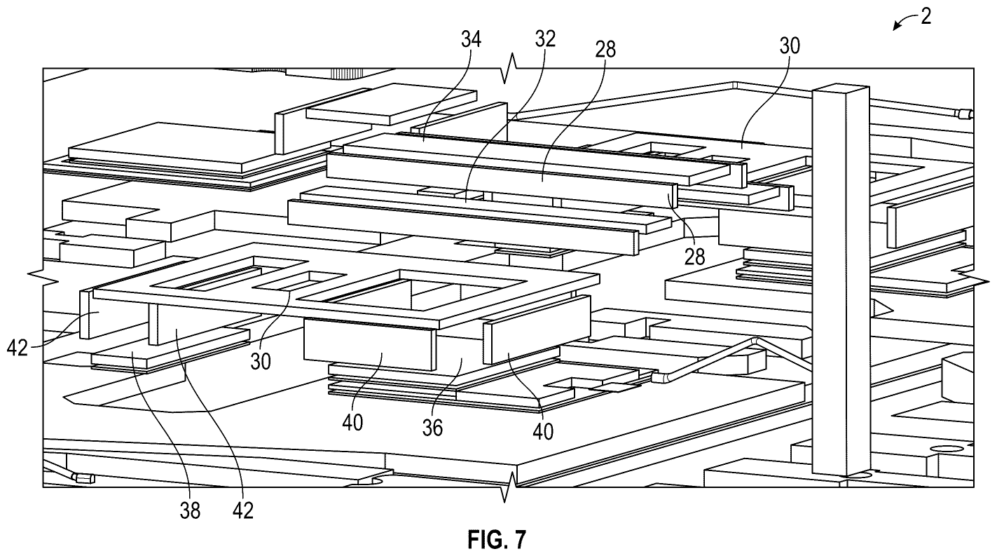

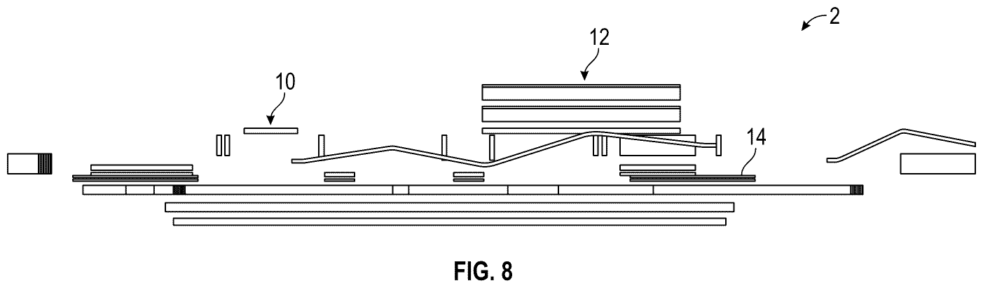

FIG. 4 illustrates the semiconductor package 2 in an exploded view. While the leads 4, 6 are illustrated as being made of separate components in this view, this is a product of the exploding of the three dimensional structure of the illustration. In various implementations, the leads 4, 6 may be made from a single leadframe that is stamped from a single sheet of metal. The upwardly oriented parts of the leads are formed by bending. The leadframe forming the leads can then soldered/welded/sintered to the substrate 8. FIG. 6 illustrates a detail view of the exploded structure of the leads 4. Referring to FIG. 6, another detail view of the exploded structure of the semiconductor package 2 provides more detail on the position of the semiconductor die 14. FIG. 7 shows another detail view of the exploded structure of the clip 12, which indicates that the clip includes major planar portions 30; transitional portions 26, 28; additional planar portions 32, 34 between the transitional portions 26, 28; contact portions 36, 38; and drop portions 40, 42 that transition between the contact portions 36, 38 and the major planar portions 30. The side view illustrated in FIG. 8 illustrates the relative Z axis/direction positioning of the various portions of the clips 10, 12 and die 14.

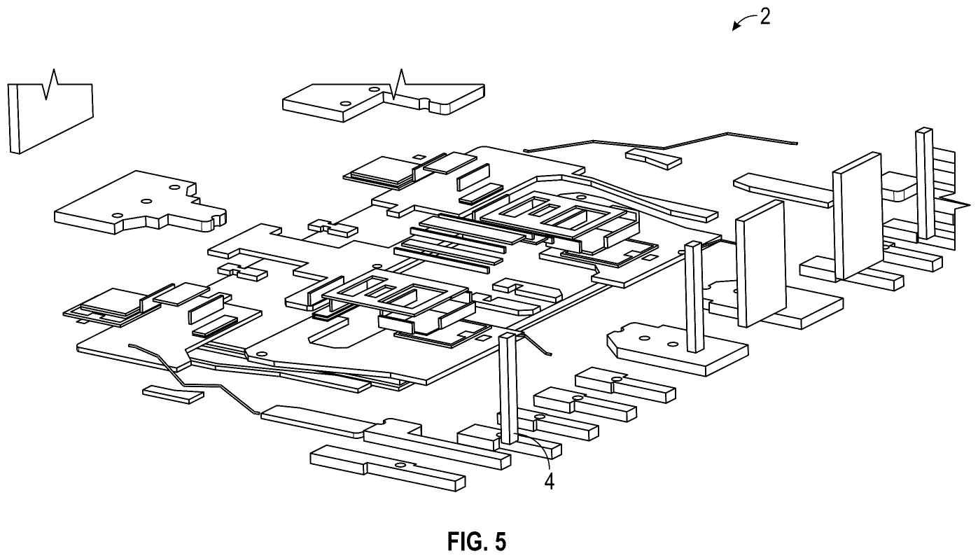

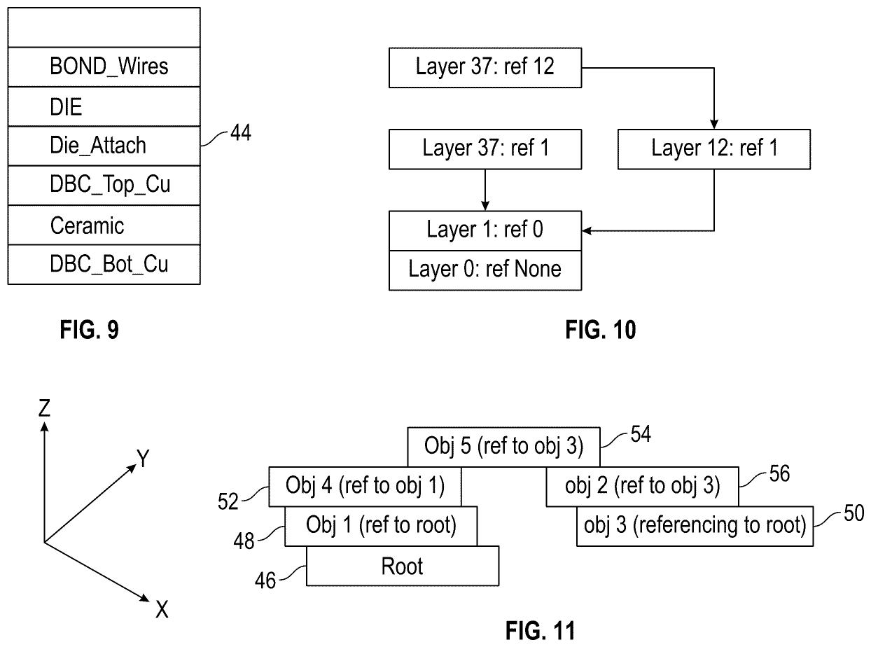

As the various views of the semiconductor package design of FIGS. 1-8 illustrate, there are more than a few portions of the semiconductor package that are not directly physically attached to the semiconductor die or the substrate. Most of the components of the clips 10, 12, for example, including the major planar portions 30; transitional portions 24, 28; and additional planar portions 32, 34 are not directly physically coupled to the semiconductor die, but coupled through other portions of the clip including the drop portions 40, 42. This disconnect between these portions and the substrate/die means that various implementations of modeling modules that consider the structure of a semiconductor package as a simple stack of components 44, as in the diagram of FIG. 9, are unable to successfully construct models of the structure of the semiconductor package with respect to electrical performance, parasitic performance, and/or thermal performance. While the use of the simple stack of layers 44 works for a substrate/die combination with electrical connectors in the form of bond wires or single layer clips, it does not work when clips of more complex structure are employed or for leads that include more than one component that directly couples with the substrate (as in the leads 4, 6).

The various system and method implementations disclosed in this document employ a dynamic stack methodology that specifies the relationship in at least Z distance/position coordinates between each component of the semiconductor package relative to one other component or relative to a root/reference layer/component. In various other implementations, the relationship in X and/or Y distance/position may also be specified. Referring to FIG. 10, this approach is illustrated in a diagram where Layer 0 is defined as the root layer, and thus has no other reference layer. Layer 1's position is then specified with reference to Layer 0 and Layer 12's position is specified with respect to Layer 1. Layer 37, however, is illustrated has having the option to be specified relative to Layer 1 or Layer 12 depending on whether Layer 37 is directly physically connected to either layer or if it is more convenient to define Layer 37's position relative to Layer 1 or Layer 12. For example, if the semiconductor package component that forms layer 37 is physically closer to Layer 1, then the Z position of Layer 37 involves a smaller magnitude value than if Layer 37's position was defined relative to Layer 12. However, if Layer 37 was directly physically coupled to Layer 12, then defining the Z position of Layer 37 relative to Layer 12 would be more convenient. Since each component of the semiconductor package, including each sub-component of the various components can be identified as a “layer” using this technique and identified in space using its relationship to another nearby or convenient component, the substrate components, die, resistors, capacitors, controllers, and other electrical connectors, such as, by non-limiting example, bond wires, wire bonds, pins, leads, clips, intermediate circuit boards, intermediate leads, or any other electrically connective structure can be represented in this way.

The result of defining the relationship of the different components of the semiconductor package using this technique down to a single root layer/component is that an object file module in the system has the ability to collect and store information regarding every component of the semiconductor package in the form of an object that corresponds to each component. In various implementations, the object includes the identity of the reference object (reference layer) for the object along with one or more characteristics of the component. The one or more characteristics may include, by non-limiting example, a component type, one or more coordinates of the component in a coordinate system that covers the semiconductor package, a material type, a size of the component, a name of the component, or any other desired characteristic of a particular component of a semiconductor package. With the identify of the reference object and the one or more characteristics, a three dimensional modeling module is then able to begin the process of constructing one or more models for the semiconductor package as will be discussed hereafter.

Referring to FIG. 11, a diagram representation of the components of the semiconductor package as objects is illustrated. Here the root object 46 has been identified. While it is the lowest object in the Z direction according to the axis on the left, this is not necessarily the case in all implementations, as this is for convenience, since any object in the diagram in FIG. 11 could be declared the root object (since the Z direction coordinate can be either positive or negative). Object 1 (48) is specified relative to the root object in its X, Y, and Z coordinate values as is Object 3 (50) even though Object 3 corresponds with a component of the semiconductor package that is not directly physically coupled to the component that the root object 46 corresponds with. Object 4 (52) is specified with a reference of Object 1 (48) and Object 5 (54) is specified with a reference of Object 3 (50), even though its corresponding component of the semiconductor package is not directly physically coupled with Object 3 (50). Finally Object 2 (56) is specified relative to Object 3 (50). This flexibility to specify reference objects as the root object or any other object in the set of objects corresponding with the components of a semiconductor package provides a great deal of flexibility for components that are connected several components away or some distance away from the component of the root object. This data structure also permits the three dimensional modeling module to accurately determine the physical connections and relationships between the different components when using this object representation as input date.

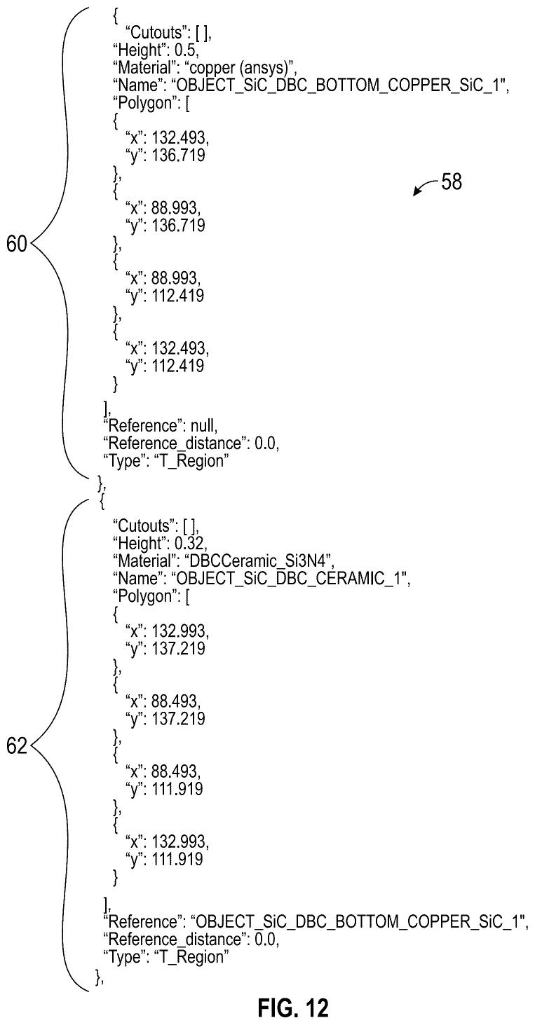

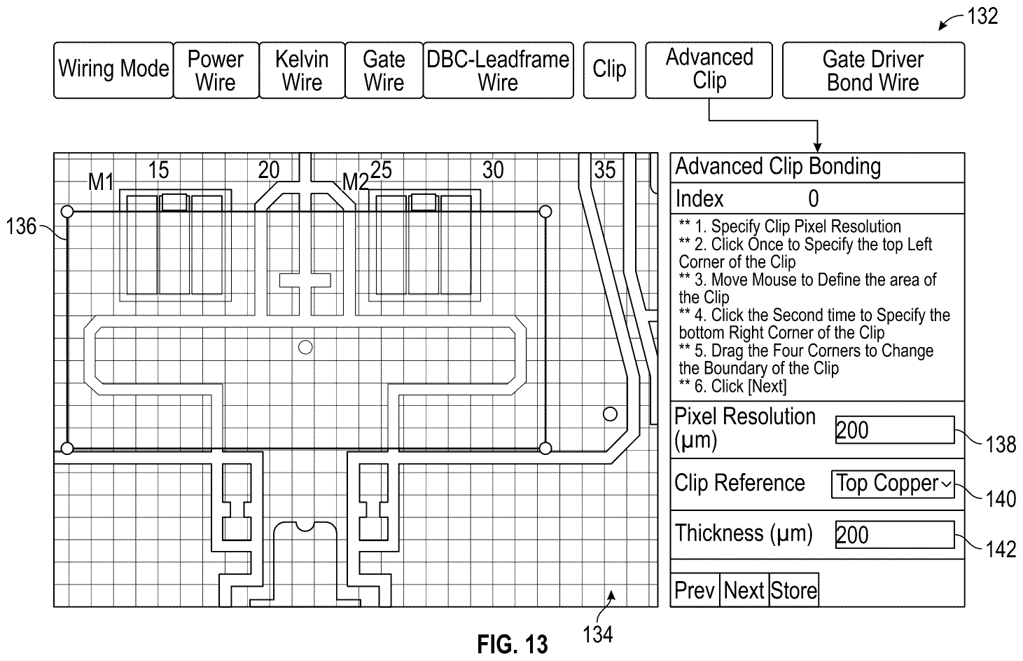

This object-oriented/driven approach to representing each component of the semiconductor package ultimately relative to a root object lends itself quite well for developing the data included in an object file formed by the object file module and then used by the three dimensional modeling module to carry out the modeling. Referring to FIG. 12, a portion of an implementation of an object file 58 in human readable format is illustrated that shows the data associated with two objects 60 and 62. The format of this particular object file implementation is JavaScript Object Notation (JSON), though in various method and system implementations other formats could be used, such as, by non-limiting example, plain text, extensible Markup Language (XML), hypertext markup language (HTML), in a database rather than a flat file, or in any other format capable of storing data in a retrievable format. Object 60 is the root object as the key “Reference” is set to the value null, indicating that there is reference object value being stored here. Object 60 also has characteristics stored with it that include its height, the presence of cutouts, a material type, its name, a type, a shape type (here a Polygon), and X/Y coordinate values of the corners of the polygon. Object 60 also illustrates that a distance from the reference object is also included, which in this case is 0.0 since object 60 is the root object.

Object 62 contains similar characteristics except that its reference object is indicated as Object 60, since the value of string name listed in the Reference key is the name of Object 60, “OBJECT_SiC_DBC_BOTTOM_COPPER_SiC_1”. The distance to the reference object is indicated as 0.0 which makes sense given object 62 corresponds with the ceramic layer in the dual bonded ceramic substrate of which Object 60 is the first layer of copper. This same format for each of the objects that includes the reference object, a distance in one, all, or any of the X, Y, or Z coordinates to the reference object and one or more characteristics of the object can be included in the object file. Implementations of an object file module work to gather, organize into an object file, and store the corresponding object file in a machine readable electronic storage coupled with the object file module. One or more processors may be used to operate machine readable instructions that direct the operation of the object file module in various system implementations.

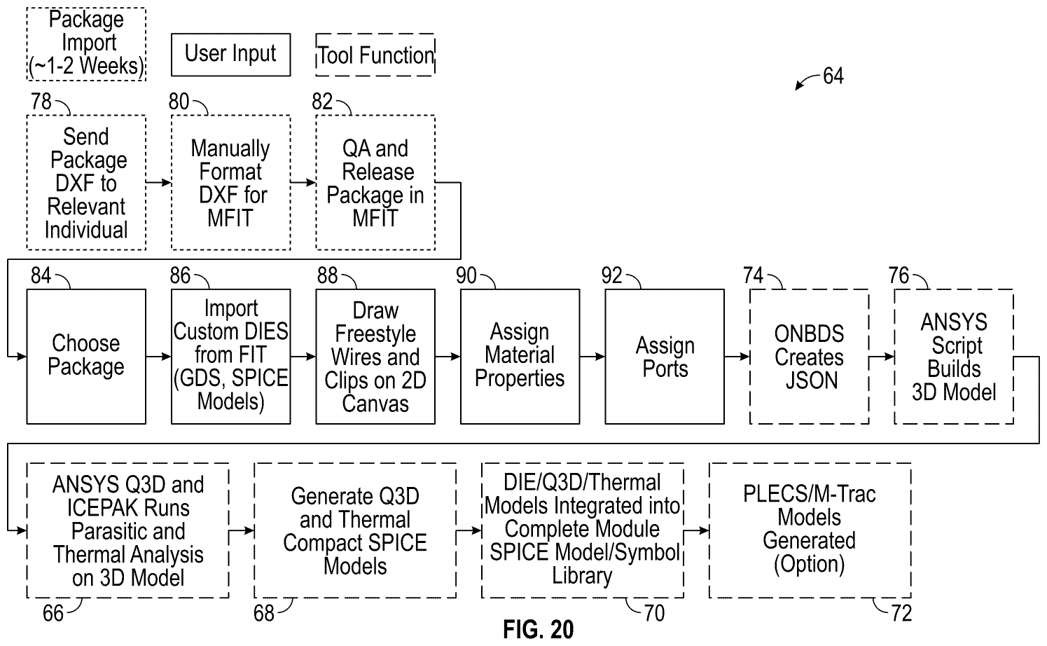

With the object file in hand, the system and method implementations are then ready to begin the process of developing various modules including three dimensional models for the semiconductor package so that the various electrical and thermal parameters of the semiconductor package can be determined. Referring to FIG. 20, a flow chart of an implementation of a method of generating models of a semiconductor package 64 is illustrated. The output of this method involves the creation of SPICE model(s) for the semiconductor package along with various models of the thermal and electrical performance of the semiconductor package including the semiconductor die included in the package. The goal of this exercise is to create sufficiently accurate electrical and/or thermal models to allow circuit designers to reliably incorporate the resulting semiconductor package in a circuit board/motherboard design and avoid the identification of failures when the device/system is ultimately built due to incorrect/suboptimal performance by the semiconductor package. Further information regarding the package modeling activity in the dotted line modules 66, 68, 70, and 72 may be found in the following references: U.S. Pat. No. 11,481,532 to Victory et al, entitled “Systems and methods for designing a discrete device product,” Ser. No. 17/076,039, filed Oct. 21, 2020, issued Oct. 25, 2022 (the '532 patent); U.S. Pat. No. 11,481,533 to Victory et al, entitled “Systems and methods for designing a discrete device product,” Ser. No. 17/076,072, filed Oct. 21, 2020, issued Oct. 25, 2022 (the '533 patent)); and application Ser. No. 18/058,382 to Xiao et al, entitled “Automated power discrete and module model generation for system level simulators,” filed Nov. 23, 2022 (the '382 application); the disclosures of each of which are hereby incorporated entirely herein by reference.

In this document, the work of the object file module is represented in dotted line box 74 and the work of the three dimensional modeling module is represented in dotted line box 76. In the method implementation illustrated in the process flow of the flow chart of FIG. 20, the process begins by sending a drawing interchange format file (DXF file) of a particular semiconductor package design to a specific system user(s). This particular system user(s) has the experience and system access to engage in a manual data processing and formatting operation with the system to enter the appropriate information about the semiconductor from the DXF file to make it available in the system for other system users to select as a based package design for further modeling (boxes 78, 80, 82). As this is a manual process that involves quality assurance (QA), the process of getting semiconductor package design entered and ready from the DXF file can take 1-2 weeks of manual work. With the semiconductor package design incorporated into the system, system users can then select it (box 84), specify particular semiconductor die and import the associated modeled die SPICE models and Graphic Design Systems (GDS) models (box 86). In the system a computer interface enables the user to lay out various electrical connectors (bond wires, clips, pins, etc.) on the semiconductor package design along with place the particular semiconductor die (box 88) while assigning material properties (box 90) and assigning one or more ports (box 92) to the design. At this point, the object file module is ready to take the coordinate information regarding the various objects in the design and generate an object file which in this implementation is formatted as a JSON file (box 74). The object file is then forwarded to the three dimensional modeling module which begins its analysis by taking the object file and using it to build a three dimensional model of the semiconductor package design that includes all of the components of the package (semiconductor die, wire bonds, clips, pins, and substrates) which is then used in the subsequent thermal, electrical, and model development operations (box 76) illustrated in FIG. 20.

This manual data entry process, however, is time consuming and, despite the use of manual data entry, is unable to comprehend semiconductor package designs like the one illustrated in FIGS. 1-8 because the object file module in this method implementation only constructs and references the objects in the semiconductor package according to the layer model of FIG. 9. Because of this, the method implementation 64 illustrated in FIG. 20 is unable, even with manual data entry, to construct an object file that can be used to construct an accurate three dimensional model for use in the subsequent modeling operations.

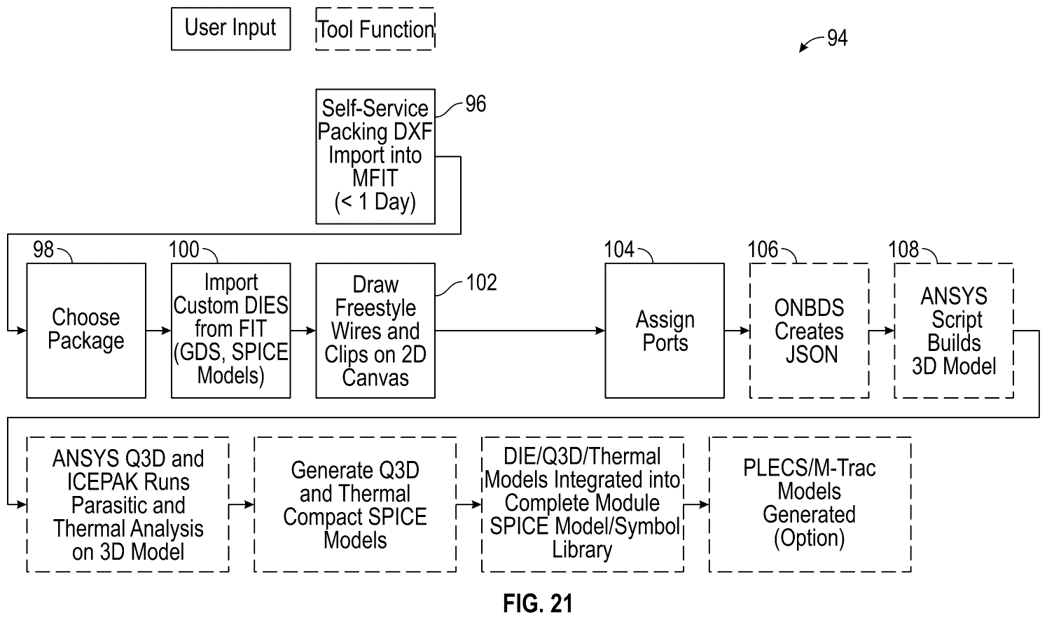

Referring to FIG. 21, a flow chart of another implementation of a method of generating models of a semiconductor package 94 is illustrated. In contract with the method implementation 64 illustrated in FIG. 20, this method utilizes an automated DXF file processing operation that allows an ordinary system user to import a DXF file and perform the needed set up activity to allow the associated semiconductor package design to be made available in the system (box 96). In this process, the various material properties of the components of the semiconductor package can be assigned, so the user does not need to enter these when designing a particular semiconductor package based on the semiconductor package design (see the flow of boxes 98, 100, 102, 104, each of which is similar to the corresponding method implementations represented in the flow of FIG. 20). In this method implementation, the resulting plurality of objects associated with the components of the semiconductor package are related using the layer/object reference approach of FIGS. 10 and 11, which allows for, as previously described, the physical relationships of the semiconductor package to be accurately represented using this flexible reference object approach based on the root object. In this method implementation, the object file module is configured to utilize the root object and reference object assigned to each of the plurality of objects corresponding with the plurality of components in the semiconductor package designed to create a corresponding object file, in this case a JSON formatted file (box 106). The resulting object file is received by the three dimensional modeling module and used to build an accurate three dimensional model that includes the physical relationships of all of the semiconductor package components (box 108). The method implementation 94 is capable of creating a model for a semiconductor package like that illustrated in FIGS. 1-8, and in considerably less time because the use of the root object and flexible reference technique also facilitates importing and creation of a new package into the system without the need for manual processing by an experienced user. The resulting three dimensional model is then used in the method implementation in a similar manner as described for the similar method elements illustrated in the method implementation of FIG. 20.

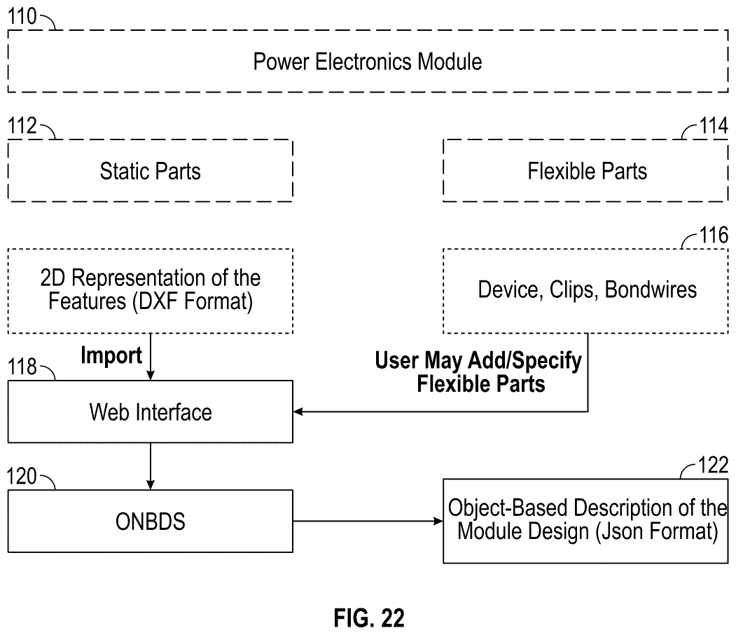

Referring to FIG. 22, a diagram of the self-service process illustrated in boxes 96-106 is illustrated. Here, the semiconductor package (here a power electronics module 110) can be described as including both static parts 112 and flexible parts 114. Those parts that are considered static are those included in the DXF file associated with the package design because they are the result of a separate design activity that culminated in the creation of the DXF file itself. These static components are not those that the method implementation is designed to adjust the position of, and so are handled in the system as a plurality of objects each corresponding with a semiconductor package component that has an already defined physical relationship with one or more of the other components of the semiconductor package. This plurality of objects and the association relationships (the static parts/objects) are gathered/formed from processing of the DXF file.

Flexible parts 114 include those that the user has the ability to select and place (clips, die, bond wires, etc. 116) using the system and method implementations disclosed herein to accommodate a desired degree of performance or tailor the package design to a particular customer's specifications/configuration/performance requirements. As illustrated, the system creates a computer interface (web interface 118) that is able to, in a first computer interface, allow for importing of the DXF file and processing and, in a second computer interface, allow the user to add/specify the location of the flexible parts. After processing of the DXF file and the placement of the flexible parts, the object file module 120 processes the objects and assigns/uses their respective reference objects including the root object to form the object file (in this case generated in a JSON format) 122.

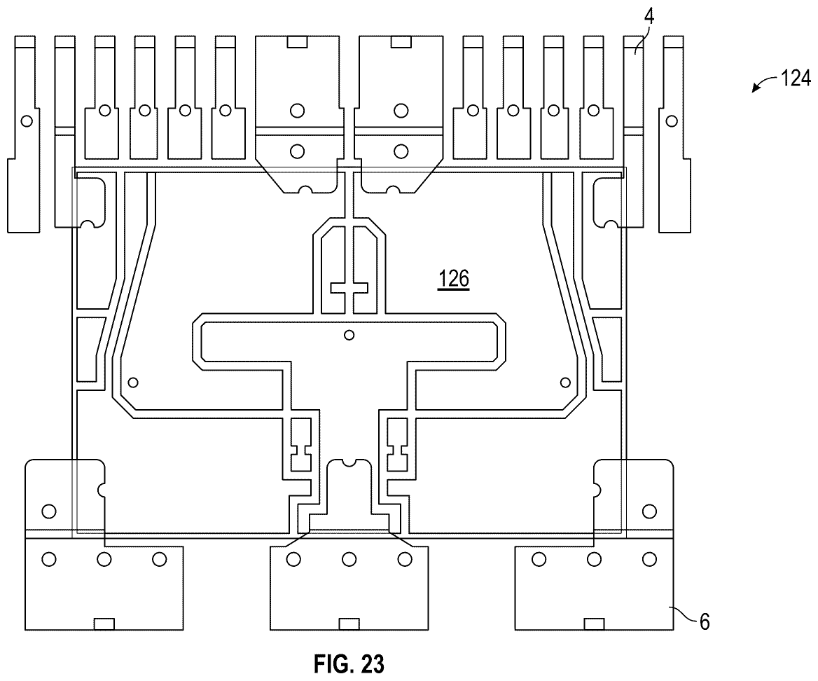

Referring to FIG. 23, a two dimensional graphical representation 124 of a semiconductor package design included in a DXF file corresponding with the semiconductor package design of FIGS. 1-8 is illustrated. Here the pattern of the top layer 126 of the dual bonded copper (DBC) substrate is illustrated along with the location and dimensions of various components of the leads 4, 6 that are horizontally/parallel oriented with the substrate are included. These components all need to be associated with corresponding objects so that they can be assembled into a three dimensional model of the package for subsequent modeling.

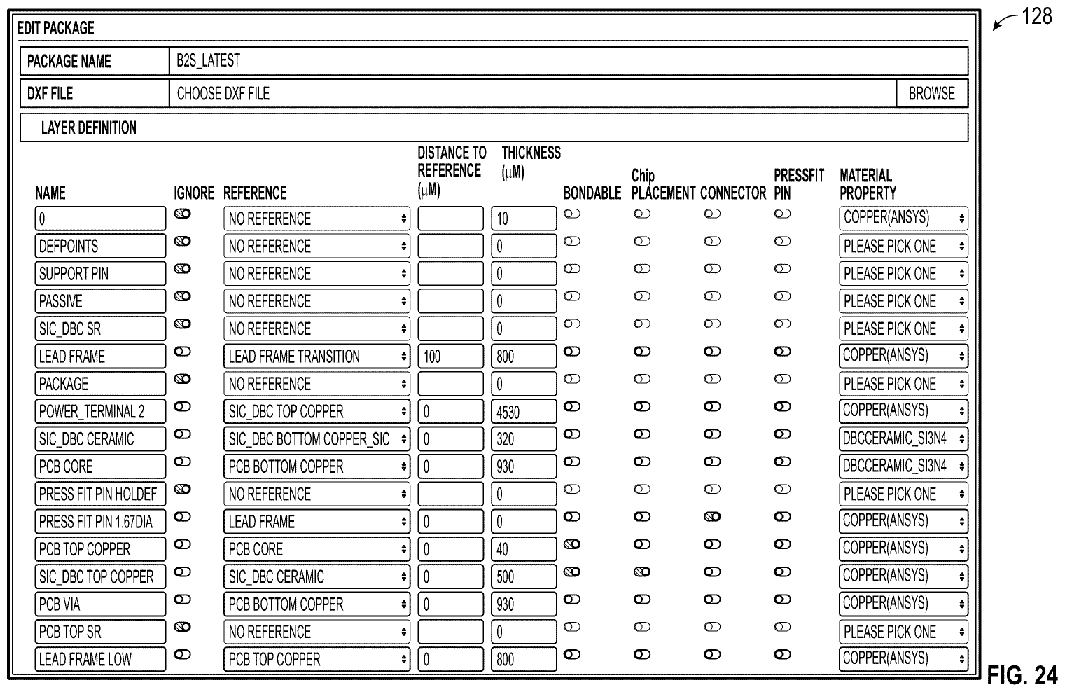

FIG. 24 illustrates an implementation of a first computer interface 128 used by the user to import a DXF file and provide needed processing feedback so that the plurality of objects corresponding with the components of the semiconductor package included in the DXF file can be properly created and referenced using the root object and each other. This first computer interface also allows the user to perform via automatic selections using various selectors and drop down menus what the experienced user had to do manually to create/import the package design into the system so it is available to all users of the system. As illustrated, a wide variety of options, material types, device specifications, and other parameters can be adjusted/set/assigned by the user using the first computer interface 128.

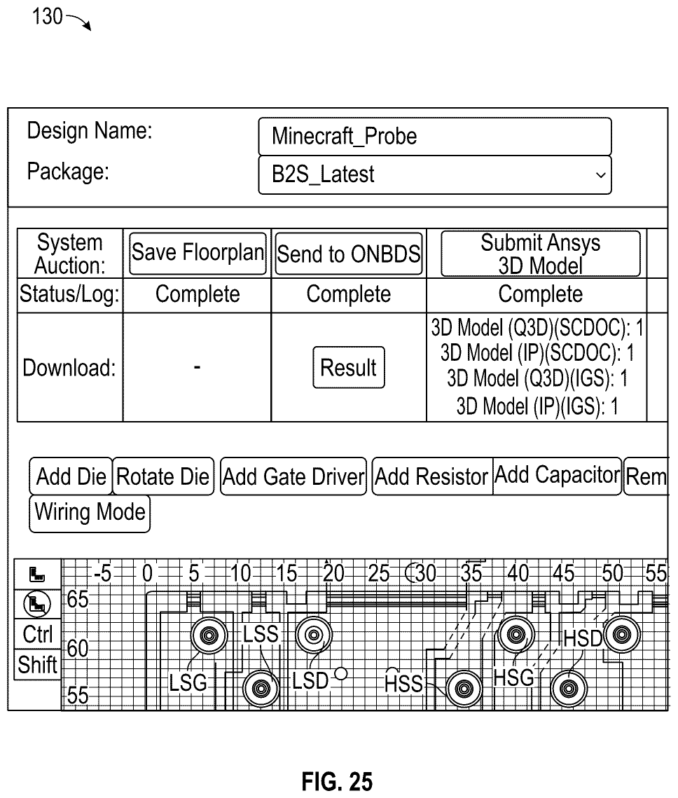

Following uploading of the DXF file and processing using the first computer interface 128, the system then, referring to FIG. 25, generates a second computer interface 130. As illustrated, this second computer interface provides the user with a visual two dimensional canvas on which is drawn the objects from the DXF file and which allows the user to select and place the various flexible objects like semiconductor die, gate drivers, resistors, capacitors, bond wires, clips, or any other desired package component that the system permits the user to include. As each flexible component is selected and placed, its coordinates (X, Y, Z) and the relevant characteristics are received by the system and included in an associated object for that component including the assigning of a relationship between that component and the root object or another object of the plurality of objects of the semiconductor package. When the placement of the flexible components is completed, a button (here the Save Floorplan button) is used to initiate generation of the objects, recording of the coordinates, assigning the relationships, and the recording of the one or more characteristics of the objects in the package to memory. Another button (here the Send to ONBDS button) is used to send the objects and associated data to the object file module which then takes the plurality of objects and completes the assigning of the data to each object and formatting of the objects into a desired object file format like any disclosed herein (here a JSON formatted file). When this process is completed, the second computer interface also includes a button (here the Submit Ansys 3D model) which begins the processing of the object file by the three dimensional modeling model to form a three dimensional model used by the other system components to complete the modeling of the semiconductor package designed.

As illustrated, the second computer interface also includes various buttons/selectors that allow the user to add a semiconductor die, rotate a semiconductor die, add a gate driver or other operational component, add a resistor, add a capacitor, and enter a wiring mode where bond wires and clips can be placed. In the second computer interface, the package design is selected to populate the canvas with the information from the objects created by processing the DXF file. Also, when a semiconductor die is selected and placed, the system also selects a corresponding die SPICE model in the system with that die and associates it with the semiconductor package being created for later model processing.

The foregoing second computer interface is utilized in various system and method implementations. This second computer interface can also include the option/interface design that permits the user to design clips for use with one or more die/components of the package which can then be represented as objects in the object file using the reference layer system of FIGS. 10-11. This clip design interface may be accessed by the user pressing a button on the second computer interface (like Advanced Clip) at which point the canvas is placed in a mode which brings up additional interface components needed to complete the design of the clip. Referring to FIG. 13, an example of the clip design interface 132 is illustrated which contains the canvas 134 which includes a two dimensional view of the static and flexible components placed up to this point in the design process. As illustrated in FIG. 13, the user has drawn a box 136 that represents the outer boundary (ies) of the clip being designed. The user then sets a pixel resolution 138 in microns that allows the system to properly calculate the size and coordinate locations of the components of the clip during the design process and during the object file creation process. The user also sets the reference object for the clip using the clip reference dropdown menu 140 which is any of the components located below the boundary box just drawn. The user can also set a thickness for the clip using the thickness drop down menu 142 in this interface view. The user then presses the next button to bring up new interface components for use in designing the rest of the clip.

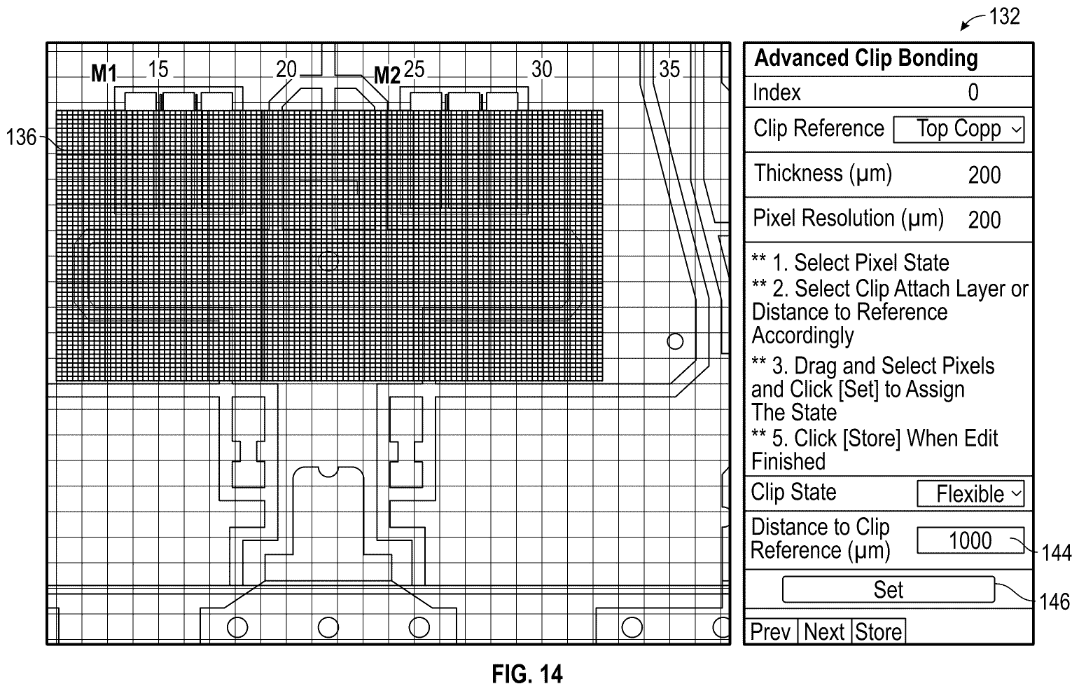

Referring to FIG. 14, the updated computer interface 132 is illustrated, and a change in the color of the boundary box 136 drawn for the clip is also illustrated. In this implementation, the color of the boundary box 136 has changed to green indicating that the area of the clip is not in contact with any other object of the package. When the clip is in this state, a Distance to Clip Reference box 144 allows the user to specify a distance between the flexible portion of the clip and the clip reference. Different flexible regions can be set to different distances from the clip reference to help the system capture changes in the shape of the clip vertically (Z direction) from the clip reference. Since the flexible portion is now represented as a set of “pixels” or sections at the previously set pixel resolution, each pixel can be individually assigned a clip reference distance or state or can be assigned as a group of selected pixels during the clip design process. Each pixel can be changed to a fixed state, meaning the corresponding area of the clip is not fixed to an object below it or change to a hole (void) state, meaning the pixel corresponds with a hole in the clip. The color of each pixel correspondingly changes to orange for fixed and transparent for hole. While these colors are used in this implementation, any of a wide variety of other contrasting colors schemes could be employed in various implementations. When the fixed/hole regions have been identified by selecting the appropriate pixel(s) in the flexible region of the clip, the user then presses the Set button 146 to record the coordinates of these features of the clip in memory.

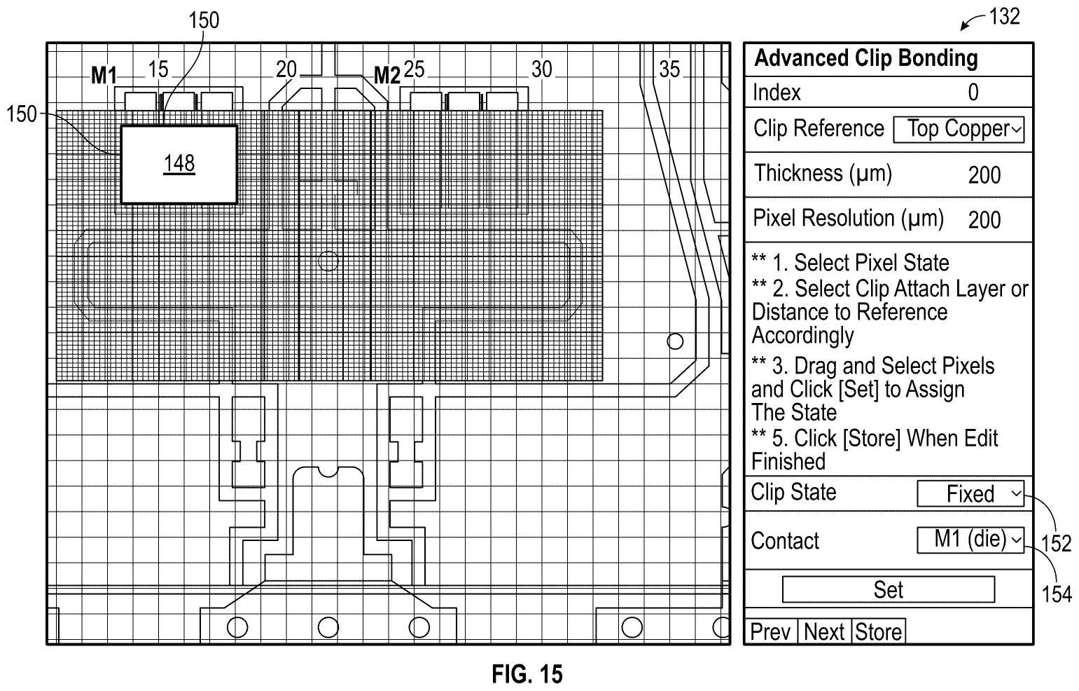

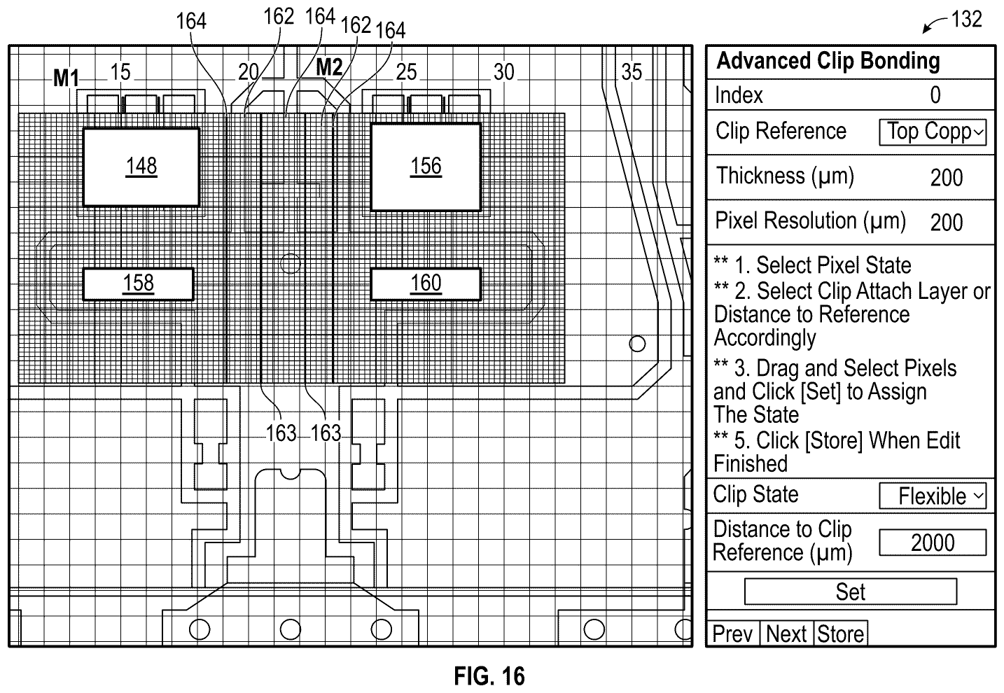

FIG. 15 illustrates the computer interface 132 after fixed region 148 has been selected and then set using the Set button 146. Fixed region 148 has been set to be fixed to physically directly contact M1 which is a semiconductor die in this implementation. Fixed region 148 is bounded by dark lines 150 which indicate a transition region in the clip exists in these areas as the material of the clip is bent/extends downwardly to reach the fixed region 148 that contacts die M1. FIG. 15 illustrates that after selection of the region of the clip, when the Clip State drop down menu 152 is set to Fixed, an additional drop down menu Contact 154 appears which allows the user to select the component below the clip to which the clip is fixed. The Set button is then pressed to save the assignment of this structure of the clip.

FIG. 16 illustrates the computer interface 132 after assignment of four fixed regions 148, 156, 158, 160. In FIG. 16, regions 162, 164 have also been assigned a distance from the clip reference different from the originally set clip reference height and so their color is changed to a different shade of green (different color) than the color of the remaining flexible portions of the clip. Transition regions marking the transitions to these different height regions are indicated by lines 163 between these regions 162, 164. As illustrated, the height of region 164 has been set to 2000 microns which is above the original 1000 micron height set for the original flexible region of the clip. In various implementations, those regions of the clip that have been defined a status and height can be hovered over with a mouse and a pop up box/window indicates the distance to clip reference value and or status is included in the pop up box/window as an aid to the user.

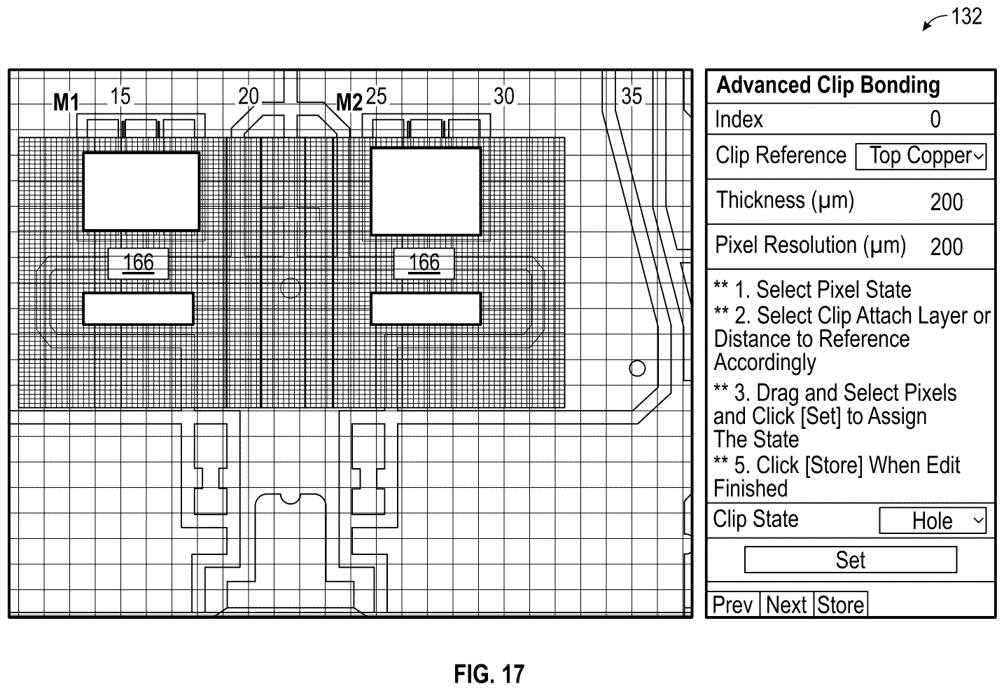

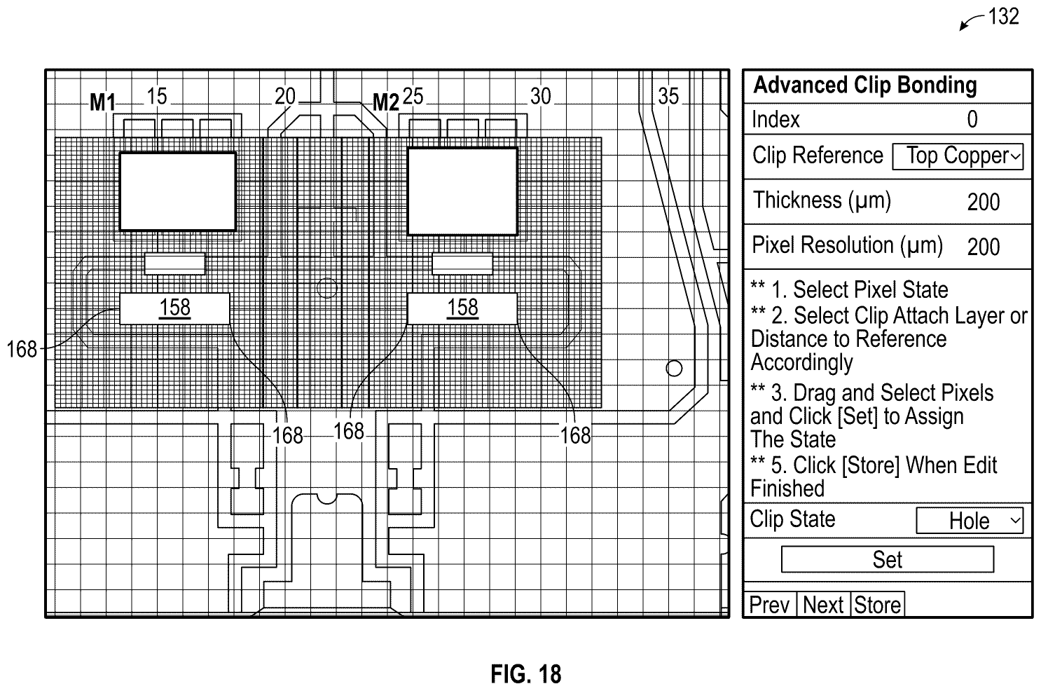

FIG. 17 illustrates the computer interface 132 following selection of the associated pixels and setting them to the Hole state to form hole regions 166. Referring to FIG. 18, the computer interface 132 is illustrated following selection of lines 168 adjacent to fixed regions 158. In this particular interface design, selection of the lines 168 changes them to a grayed state from solid black. This has the effect of indicating that the transition edges at these lines no longer exist, and so there is no transition along this edge. Not all edges in the clip need to have a transition, which is why this ability to remove the transition edges is provided for in the various method implementations disclosed herein. For example, a clip structure may include transitions down on two opposite edges while the other two opposite edges remain unconnected to the lower surface. This can happen where the transition down is enabled by cuts in the metal made along the unconnected opposite edges which allow the material of the clip to transition down on two sides while leaving openings on the other two sides.

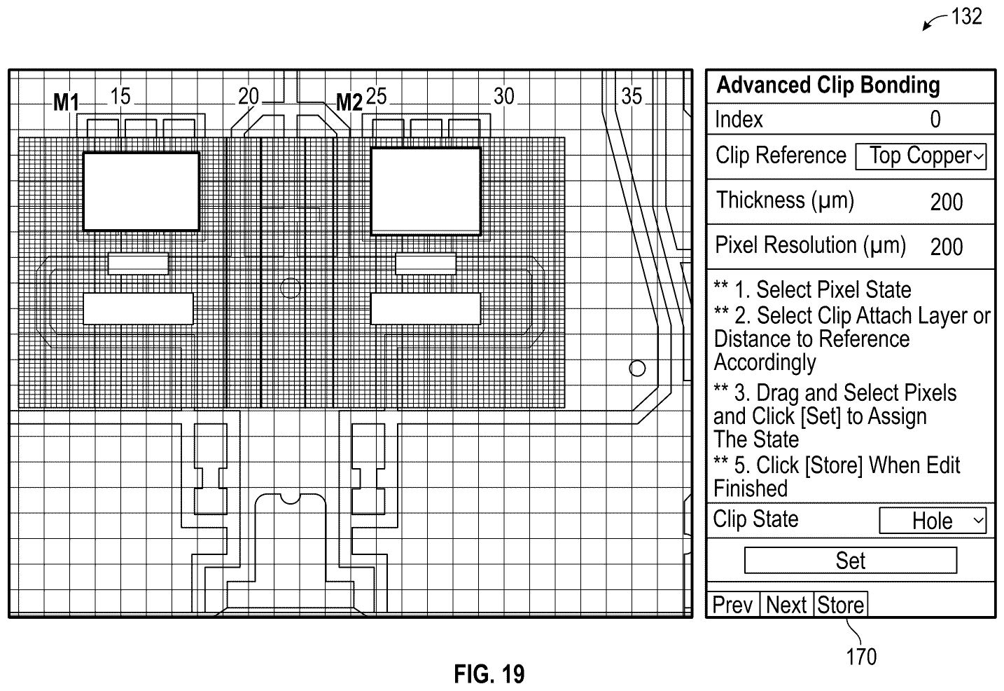

FIG. 19 illustrates the computer interface 132 when the design process for the clip is completed. The user then presses the Store button 170 and the system then records the coordinates and attributes of all of the elements of the clip that have been designed and creates the corresponding objects for inclusion in the object file using the object file module and various method and system component described herein.

The various system implementations disclosed herein utilize various implementations of a method of generating an object file for modeling with a three dimensional modeling module. The method includes using one or more processors to receive a DXF file from a user using a first computer interface like those disclosed herein where the DXF file includes a plurality of objects. The method also includes using a second computer interface to receive a selection of a semiconductor package type from the user and to receive a selection of a SPICE model of at least one semiconductor die. The selecting of the SPICE model may, in various method implementations, occur automatically when the user selects a particular semiconductor die type that is already available in the system as the SPICE model for the die is also already associated with the die and loaded into the system.

The method also includes using the second computer interface to receive coordinates of a location of the at least one semiconductor die (as when the die is placed on the canvas as the desired location) and receiving coordinates of a location of at least one electrical connector (as when the particular electrical connector is placed on the canvas at the desired location). The method also includes using an object file module to determine a root object of the plurality of root objects of the DXF file and, using the coordinates of the location of the at least one semiconductor die, to assign a relationship of the at least one semiconductor die relative to the root object or any one object of the plurality of objects. While the method includes this element, if the semiconductor die is the root object, various method implementations would instead include assigning relationships of the the other objects of the plurality of objects to the at least one semiconductor die as the semiconductor die is the root object.

The method also includes using the object file module to record in an object file the reference object for the at least one semiconductor die (if the semiconductor die is not the root object) and one or more characteristics of the at least one semiconductor die (which may be any disclosed in this document). The method also includes using the object file module to use the coordinates of the location of the at least one electrical connector to assign a relationship of the at least one electrical connector relative to the root object (if the at least one electrical connector is not itself the root object) or any one object of the plurality of objects. The method also includes using the object file module to record in the object file the reference object for the at least one electrical connector and one or more characteristics of the at least one electrical connector (which may be any disclosed in this document). The method also includes, for each object of the plurality of objects, assigning a relationship for each object relative to the root object or another object of the plurality of objects to establish a reference object for each object. The method also includes, for each object of the plurality of objects, recording in the object file the reference object for each object and one or more characteristics of each object. The method also includes storing the object file in any format disclosed herein for subsequent use by the three dimensional modeling module.

The various system and method implementations disclosed herein utilize implementations of an object file used for modeling by the three dimensional modeling module. Implementations of an object file include (in the form of machine readable information/code/instructions) a first object defined as a root object where the first object corresponds with a first component of a semiconductor package. The first component could be any component of the semiconductor package including the semiconductor die in various implementations. The object file also includes a second object corresponding with a second component of the semiconductor package that is directly physically coupled to the first component of the semiconductor package where the second object includes a reference to the root object. Again, this second object could correspond with any other component of the semiconductor package that is not the component that corresponds with the root object. The object file also includes at least a third object that correspond with a third component of the semiconductor package where the third object has a reference to the root object where the third component of the semiconductor package is directly coupled with a fourth component of the semiconductor package that is indirectly physically coupled to the second component of the semiconductor package. Here, the structure of the objects in the object file reflects the structure of the semiconductor packages disclosed herein where various components are not directly physically coupled with the root object, but only indirectly coupled through other objects that eventually are coupled to the root object. The indirect physical coupling of the fourth component is what prevents the three dimensional modeling module to accurately model the package structure using the layer approach of FIG. 9.

In various object file implementations, the fourth component corresponds with a fourth object. This fourth object includes a reference to the root object, the second object, or the third object. In various implementations, the second object includes a Z position relative to the root object, the third object includes a Z position relative to the root object, and/or the fourth object includes a Z position relative to the root object, the second object, or the third object.

In another implementation of a method of designing a clip, the method includes using one or more processors to receive a DXF file from a user using a first computer interface where the DXF file includes a plurality of object. The method also includes using a second computer interface to receive a selection of a semiconductor package type, at least one semiconductor die type, and a clip from the user. The method also includes using the second computer interface to receive coordinates of a location of the at least one semiconductor die, receive coordinates of an outer boundary of the clip, and receive coordinates of a thickness of the clip. The method also includes, within the outer boundary of the clip, receiving coordinates of at least one fixed portion of the clip and receiving coordinates of a first transition region of the clip. As disclosed herein, the coordinates can be received as the various pixel regions of the second computer interface are selected and then set, then saved to an object file associated with the corresponding object using the object file module.

In various method implementations, the method includes receiving a distance to a clip reference for the outer boundary region. It also can include receiving a distance from a clip reference for any of the specified regions of the clip that have been identified out of the flexible region within the outer boundary region of the clip. The method also can include receiving coordinates of one or more holes in the clip. The method can also include receiving a selection of a first transition region of the clip and, in response, receiving coordinates of a line where the first transition is no longer present.

The one or more processors and related system components used in the various method implementations disclosed herein and to operate the various modules may be any remote platform(s), computing platform(s), electronic storage types, processor(s), external resources, computing devices, and/or networking components disclosed in the '532 patent, the '533 patent and/or the '382 application previously incorporated by reference. The object file module and three dimensional modeling module implementations disclosed herein may be added to the various module types disclosed in the '532 patent, the '533 patent and/or the '382 application previously incorporated by reference. With respect to the three dimensional modeling module, the three dimensional modeling module may be any similar module including a three dimensional simulation module utilizing any of the various three dimensional modeling systems/techniques disclosed in the '532 patent, the '533 patent and/or the '382 application previously incorporated by reference.

In places where the description above refers to particular implementations of semiconductor package model generating systems and implementing components, sub-components, methods and sub-methods, it should be readily apparent that a number of modifications may be made without departing from the spirit thereof and that these implementations, implementing components, sub-components, methods and sub-methods may be applied to other semiconductor package model generating systems.

What is claimed is:

1. A method of generating an object file for modeling with a three dimensional modeling module, the method comprising:
using one or more processors:
receiving a drawing interchange format file from a user using a first computer interface, the drawing interchange format file comprising a plurality of objects;
using a second computer interface:
receiving a selection of a semiconductor package type from the user;
receiving from the user a selection of a SPICE model of at least one semiconductor die;
receiving coordinates of a location of the at least one semiconductor die; and
receiving coordinates of a location of at least one electrical connector;
using an object file module:
determining a root object of the plurality of objects of the drawing interchange format file;
using the coordinates of the location of the at least one semiconductor die, assigning a relationship of the at least one semiconductor die relative to the root object or any one object of the plurality of objects;
recording in an object file a reference object for the at least one semiconductor die and one or more characteristics of the at least one semiconductor die;
using the coordinates of the location of the at least one electrical connector, assigning a relationship of the at least one electrical connector relative to the root object or any one object of the plurality of objects;
recording in the object file the reference object for the at least one electrical connector and one or more characteristics of the at least one electrical connector; and
for each object of the plurality of objects:
assigning a relationship for each object relative to one of the root object or another object of the plurality of objects to establish a reference object for each object; and
recording in the object file the reference object for each object and one or more characteristics of each object; and
storing the object file.

2. The method of claim 1, wherein the at least one electrical connector is one of at least one bond wire, at least one clip, or both at least one bond wire and at least one clip.

3. The method of claim 1, further comprising:
receiving a selection of one of a resistor, a gate driver, a capacitor, or any combination thereof from the user using the second computer interface;
receiving coordinates of a location of the one of a resistor, a gate driver, a capacitor, or any combination thereof;
using the coordinates of the location of the one of a resistor, a gate driver, a capacitor, or any combination thereof, assigning a relationship of the one of a resistor, a gate driver, a capacitor, or any combination thereof relative to the root object or any one object of the plurality of objects; and
recording in the object file the reference object for the one of a resistor, a gate driver, a capacitor, or any combination thereof and one or more characteristics of the one of a resistor, a gate driver, a capacitor, or any combination thereof.

4. The method of claim 1, wherein the second computer interface comprises a canvas portion on which the plurality of objects from the drawing interchange format file are displayed and on which the user places the at least one semiconductor die and the at least one electrical connector at a desired position relative to the plurality of objects to establish the coordinates of the location of the at least one semiconductor die and the coordinates of the at least one electrical connector.

5. The method of claim 1, wherein the second computer interface comprises a button configured to execute the object file module with a current configuration of the plurality of objects, the at least one semiconductor die, and the at least one electrical connector displayed on a canvas portion.

6. The method of claim 1, wherein the second computer interface comprises a button configured to send the object file to the three dimensional modeling module for processing.

7. An object file for modeling using a three dimensional modeling module, the object file comprising:
a first object defined as a root object, the first object corresponding with a first component of a semiconductor package;
a second object corresponding with a second component of the semiconductor package directly physically coupled to the first component of the semiconductor package, the second object comprising a reference to the root object; and
at least a third object corresponding with a third component of the semiconductor package, the third object comprising a reference to the root object, the third component of the semiconductor package directly coupled with a fourth component of the semiconductor package indirectly physically coupled to the second component of the semiconductor package.

8. The object file of claim 7, wherein the fourth component of the semiconductor package corresponds with a fourth object, the fourth object comprising a reference to one of the root object, the second object, or the third object.

9. The object file of claim 7, wherein the first object, second object, and third object each comprise one or more characteristics of the first component, second component, and third component, respectively.

10. The object file of claim 9, wherein the one or more characteristics includes one of a size, a material, or a name.

11. The object file of claim 7, wherein the second object comprises a Z position relative to the root object.

12. The object file of claim 7, wherein the third object comprises a Z position relative to the root object.

13. The object file of claim 8, wherein the fourth object comprises a Z position relative to one of the root object, the second object, or the third object.

14. The object file of claim 7, wherein a three dimensional modeling module is configured to begin modeling with the root object.

15. A method of designing a clip, the method comprising:
using one or more processors:
receiving a drawing interchange format file from a user using a first computer interface, the drawing interchange format file comprising a plurality of objects;
using a second computer interface:
receiving a selection of a semiconductor package type from the user; and
receiving from the user a selection of at least one semiconductor die;
receiving from the user a selection of a clip; and
using the second computer interface:
receiving coordinates of a location of the at least one semiconductor die; and
receiving coordinates of an outer boundary of the clip;
receiving a thickness of the clip;
within the outer boundary of the clip, receiving coordinates of at least one fixed portion of the clip; and
within the outer boundary of the clip, receiving coordinates of a first transition region of the clip.

16. The method of claim 15, wherein receiving coordinates of the outer boundary of the clip further comprises receiving a distance to a clip reference.

17. The method of claim 15, further comprising, within the outer boundary of the clip, receiving coordinates of a hole in the clip.

18. The method of claim 15, further comprising, within the outer boundary of the clip, receiving coordinates of a second transition region of the clip and defining a flexible region between the first transition region and the second transition region.

19. The method of claim 15, further comprises receiving a selection of a portion of the first transition region of the clip and, in response, receiving coordinates of a line where the first transition region is not present.

20. The method of claim 15, further comprising generating a plurality of objects corresponding with the clip with an object file module and storing the plurality of objects in an object file.
